(19) United States
(12) Patent Application Publication
(10) Pub. No.: US 2024/0189816 A1
(43) Pub. Date: Jun. 13, 2024

(54) Microfluidic Dual Cartridge, Microfluidic Analysis Device, Process for Manufacturing a Dual Cartridge and an Analysis Device, and Method for Using a Microfluidic Analysis Device

(71) Applicant: Robert Bosch GmbH, Stuttgart (DE)

(72) Inventors: Julian Kassel, Pforzheim (DE); Dieter Amesoeder, Ludwigsburg (DE); Marc Meier, Kernen I. R. (DE); Jochen Feichtinger, Ilsfeld-Helfenberg (DE); Stephan Geise, Bueren (DE); Jochen Hoffmann, Renningen (DE); Daniel Sebastian Podbiel, Rutesheim (DE)

(21) Appl. No.: 18/554,904

(22) PCT Filed: Mar. 22, 2022
(86) PCT No.: PCT/EP2022/057411

§ 371 Date: Oct. 11, 2023

(30) Foreign Application Priority Data
Apr. 13, 2021 (DE) 10 2021 203 636.8

(51) Int. Cl. B01L 3/00

(52) U.S. Cl. CPC B01L 3/502715; B01L 3/502707; B01L 2200/025; B01L 2200/027; B01L 2200/04; B01L 2300/0816; B01L 2300/0887; B01L 2300/168

(57) ABSTRACT

A microfluidic dual cartridge includes a first microfluidic analysis device for processing sample material and a second microfluidic analysis device for processing sample material. The two analysis devices being interconnected at a connection point, which is configured to bring about a defined separation of the first microfluidic analysis device and the second microfluidic analysis device under the effect of a force.

### THE PRIOR ART

The invention proceeds from a microfluidic dual cartridge, a microfluidic analysis device, a process for manufacturing a microfluidic dual cartridge, a process for manufacturing a microfluidic analysis device, and a method for using a microfluidic analysis device belonging to the class of patent specified in the independent claim.

Microfluidic analysis systems, called lab-on-chips or LoCs, permit an automated, reliable, fast, compact, and cost-effective processing of patient samples for medical diagnostics. By combining a variety of operations for controlled manipulation of fluids, complex molecular diagnostic test procedures can be carried out on a lab-on-chip cartridge. Lab-on-chip cartridges can be produced from polymers, for example, using series production processes such as injection molding, injection punching, punching, or laser transmission welding.

### DISCLOSURE OF THE INVENTION

In light of this, with the approach presented herein, a microfluidic dual cartridge, a microfluidic analysis device, a process for manufacturing a microfluidic dual cartridge, a process for manufacturing a microfluidic analysis device, and a method for using a microfluidic analysis device according to the main claims are presented. By the measures listed in the dependent claims, advantageous developments and improvements of the apparatus specified in the independent claim are possible.

The degree of complexity of a molecular diagnostic test sequence can vary depending on the chosen application. The requirements placed on a lab-on-chip cartridge therefore also differ depending on the application. In addition to providing a particularly universal lab-on-chip cartridge that addresses a particularly wide range of applications, providing particularly cost-efficient lab-on-chip cartridges that have an adapted, i.e., for example, requirements-optimized, range of applications is especially useful. This raises the question of a particularly advantageous configuration for such lab-on-chip cartridges. In this context, particularly low-cost and advantageous feasibility of the lab-on-chip cartridge plays an important role. The dual cartridge presented herein may advantageously correspond to a range of applications optimized for requirements and may be manufactured in a particularly advantageous and cost-efficient manner.

A microfluidic dual cartridge is presented, said dual cartridge comprising a first microfluidic analysis device for processing sample material as well as a second microfluidic analysis device for processing sample material, the two analysis devices being interconnected via a connection point which is designed to bring about a defined separation of the first analysis device and the second analysis device under the effect of a force. For example, the first and second analysis devices may be substantially a standardized or a variant of a lab-on-chip cartridge optimized for a particular microfluidic analysis process. The analysis devices are manufactured contiguously via the connection point so that the dual cartridge can form a contiguous twin, or generally a multiple of two, or generally several, separately usable analysis devices or lab-on-chip cartridges, which can each be provided for individual use. The first and second analysis devices of the dual cartridge can be configured to be used in an analysis device after separation, for example for the analysis of body fluids and timely diagnostics in medical practices and hospitals. For example, the analysis device may also be configured to process other cartridge types. In addition, after separation, the dual cartridge can be grasped by the hand of a user in both spatial directions, at least in partial areas. In this way, the compact design of the dual cartridge allows for particularly simple, secure, and convenient handling by the user, for example when adding a sample into one of the analysis devices or when adding an analysis device into an analysis unit. Due to the particularly compact implementation of the analysis devices as a dual cartridge, advantageously the material requirement can be almost halved compared to a standard cartridge, for example. The solution is thus particularly resource-conserving and sustainable, as, for example, during disposal, the amount of waste can be reduced. Furthermore, the reduced material requirement also contributes to a reduction in manufacturing costs.

According to one embodiment, the first analysis device and the second analysis device can be of identical shape and additionally or alternatively functionally identical so that they can be individually used after the separation. For example, the first and second analysis devices may have been constructed uniformly during a manufacturing process and fitted with the same components in a parallelized manner. Advantageously, only minor modifications in the manufacturing process compared to individual analysis devices are necessary, wherein by parallelized production of the first and second analysis devices in the form of a dual cartridge, the production speed can be increased and costs reduced.

According to a further embodiment, the connection point can be formed at least in part as a material-fit predetermined breaking point and additionally or alternatively a cut edge. For example, the first and the second analysis device may be mechanically connected to each other via the connection point in the form of a predetermined breaking element or a cut edge. In addition, for example, the dual cartridge may be made at least in parts from an amorphous plastic. The brittle material properties of the amorphous plastic used advantageously allow for simple mechanical separation of the dual cartridge by breaking or cutting along a cut edge at a transition with different cross-sections by shear, bend, or torsion forces. In addition or alternatively, the dual cartridge can thereby be enabled for a particularly simple manual separation of the dual cartridge into two separately usable lab-on-chip cartridges by a user, for example by manual breaking or by means of commercially available scissors.

According to a further embodiment, the connection point may be formed by an injection point in an injection molding process. For example, when manufacturing the dual cartridge using an injection mold having at least two cavities, the injection point of a hot runner may be positioned at a transition between the cavities. Subsequently, for example, a plastic melt may be injected over the injection point and the connection point, thus simultaneously filling a cavity for the first analysis device and a cavity for the second analysis device. Thus, advantageously, in a short manufacturing and assembly time, inexpensive cartridges can be manufactured with a separating device but without visible gate points in which the number of error sources can be simultaneously reduced.

According to another embodiment, the connection point may be formed at least in part by complementary form-fit connection elements for form-fitting connection of the first analysis device to the second analysis device. For example, in addition to the implementation of the connection point as a predetermined breaking point or cut edge, the connection of the two analysis devices may also be achieved, for example, by a press connection with a form-fit. For example, the jigsaw-press connection may also be composed of two complementary elements, which may allow for a press connection between the first analysis device and second analysis devices by mechanically engaging one another. For example, the first analysis device may comprise a tab having a pin, whereas the complementary element of the second analysis device may be characterized by a pocket having a bore. The click-press connection can thus be achieved by engaging the tab in the pocket and the pin in the bore. As an alternative to a click-press connection, a so-called jigsaw-press connection may also be offered. For example, the jigsaw-press connection may also be composed of two complementary elements, which may allow for a press connection between the two analysis devices by mechanically engaging one another. In contrast to the click-press connection, the elements of the jigsaw-press connection may have no pin or bore, for example. Instead, the jigsaw-press connection can be based on a first element formed as a tab having a protuberance and a second complementary element configured as a pocket having an inversion. By engaging the tab having the protuberance into the pocket having the inversion, a jigsaw-press connection can be established. Advantageously, such a connection point or similar may provide stiffening between the individual analysis devices and thus facilitate handling of the entire dual cartridge.

According to another embodiment, the dual cartridge may comprise a plurality of layers. In this case, at least one layer of the plurality of layers may comprise a microfluidic network wherein the layer or further layer of the plurality of layers may be formed with the connection point. Additionally or alternatively, the layer and additionally or alternatively, the further layer may be equipped or capable of being equipped with at least one element, for example a reagent bar or reaction bead. For example, the dual cartridge may comprise two, for example, transparent carrier plates, wherein at least one of the carrier plates may be formed with, for example, microfluidic channels, chambers, and valves. For example, the microfluidic network may be duplicated such that the first analysis device of the dual cartridge may comprise a first network and the second analysis device may comprise a second network. For example, a membrane for applying pressure may be arranged between the two carrier plates. For example, the dual cartridge may be made of polymers, such as polycarbonate (PC), polystyrene (PS), styrene-acrylonitrile copolymer (SAN), polypropylene (PP), polyethylene (PE), polymethylpentene (PMP), cycloolefin copolymer (COP, COC), polymethyl methacrylate (PMMA), polydimethylsiloxane (PDMS), or thermoplastic elastomers (TPE) based on polyurethane (TPU) or styrenic block copolymer (TPS), manufactured by series production methods such as injection molding, injection stamping, thermoforming, punching, or laser transmission welding. This has the advantage that after being separated, the first and the second analysis device can each be used for analysis processes, for example for investigating sample material.

In addition, an additional layer of the plurality of layers may comprise a film, wherein the film may comprise an indentation and additionally or alternatively a perforation for defined separation of the first analysis device and the second analysis device. While rigid polymer parts for forming a dual cartridge can, for example, each be connected to one another via a connection point to the predetermined breaking point and via a press connection, for example, to enable defined and simple separation of the dual cartridge, an additional layer of a thinner polymer film, for example, may require other concepts, which may allow particularly advantageous manufacture of the dual cartridge in the form of a polymer multilayer construction. For example, a film may have one or more perforations or one or several indentations as part of the dual cartridge, which may be arranged along, for example, a separating line between the first analysis device and the second analysis device. Thus, advantageously, when the analysis devices are separated, for example by breaking the predetermined breaking point of the connection point, a defined separation of the film can be performed simultaneously.

In addition, a microfluidic analysis device is presented from a variant of the previously presented dual cartridge, wherein the analysis device comprises at least a portion of the connection point. For example, the analysis device may be manufactured as part of a dual cartridge together with an analysis device of identical shape and function and separated along the connection point of the dual cartridge after manufacture. This has the advantage that the analysis device can be produced in a material-saving and cost-saving manner. In a further particularly advantageous embodiment, for example, the separated dual cartridge may have interfaces for processing the lab-on-chip cartridge in an analysis unit, for example, wherein the interfaces, for example, may be arranged in the same positions as a standard cartridge, which may be processed in the same analysis unit. In this way, both cartridge types can particularly advantageously be processed in the same analysis unit, for example for molecular diagnostic analysis of a sample substance.

In addition, a method for manufacturing a variant of the previously presented microfluidic duo cartridge is presented, wherein the method comprises a step of providing a layer to the dual cartridge. In this case, the layer comprises a first portion for forming a part of the first analysis device and a second portion for forming a part of the second analysis device, and the connection point for connecting the two portions. In addition, the method comprises a step of providing the layer with a further layer to produce the dual cartridge. For example, the layer and the further layer can be formed in an injection molding process, arranged on a tool carrier and connected to each other and, for example, also to other layers by means of a laser welding process. For example, the dual cartridge may be designed in such a way that it can be manufactured on a production line, which may also be configured for the manufacture of a standard cartridge. In particular, when manufacturing the dual cartridge, the cycle time of the production line can almost be maintained compared to the manufacture of the standard cartridge. In this way, for example, the number of separately usable lab-on-chip cartridges which can be manufactured at a predetermined time interval on the production line can be nearly doubled. By designing a lab-on-chip cartridge as a dual cartridge, particularly advantageous manufacturing can be achieved. In particular, a dual cartridge may be processed, for example, on a surface comparable to a standard cartridge. On the one hand, this enables particularly cost-efficient and efficient manufacture of the dual cartridge. On the other hand, for example, the same production line can be used variably for the production of at least two different cartridge types, for example standard cartridges and dual cartridges, without any major adjustments. By having the individual layers or semi-finished products for manufacturing a dual cartridge being each composed of two contiguous semi-finished products for forming lab-on-chip cartridges, the number of semi-finished products to be handled during production can be reduced. In this way, a particularly advantageous, parallelized manufacture of lab-on-chip cartridges in the form of a dual cartridge is possible. In addition, the dual cartridge can be packaged contiguously, comparable to a standard cartridge, for example in a resealable pouch. In this way, for example, a packaging line used for packaging the standard cartridge may also be used for the packaging of the dual cartridge and comparable packaging dimensions are made possible, which may be advantageous for further logistics.

According to one embodiment, in the step of providing, the connection point can be indented to form a predetermined breaking point and additionally or alternatively an interface. For example, in an injection mold with at least two cavities, the injection point of a hot runner can be positioned at a transition between the cavities. Immediately after injection of the transparent plastic melt, a punch with a sharp cutting edge directly opposite in the ejector side can be advanced over the entire plate thickness via the ejector punching function of the injection molding machine and produce a notched thin transition cross-section or several small connection points. However, the transition can still be stable enough to allow the layer to be removed from the injection mold and fed to the assembly line after a certain cooling time in conjunction with handling. Advantageously, a predetermined breaking point or cut edge can be produced in the dual cartridge in a time-saving and cost-saving manner, which can allow particularly simple separation of the dual cartridge into two separately usable lab-on-chip cartridges. In this way, the separation of the dual cartridge can be performed, for example, directly by the user.

According to a further embodiment, the method may comprise a step of equipping the layer and additionally or alternatively, the further layer, with at least one element. Equipping with additional elements can be accomplished by inlaying, inserting, or attaching and additionally or alternatively snapping, for example. For example, the element may be a reagent bar, which may be inserted into a liquid reagent receptacle provided for this purpose. Additionally or alternatively, it may be, for example, a reaction bead, i.e., a freeze-dried or lyophilized solid reagent, which may be introduced, for example, into a recess provided for this purpose in a layer or assembly of a plurality of layers to form the dual cartridge. Additionally or alternatively, the element may be, for example, an array carrier element, such as a hybridization array or a microcavity array, which may be employed to perform detection reactions in the dual cartridge. For example, the array carrier element may be glued into a recess in the layer or an assembly of a plurality of layers to form the dual cartridge. In particular, double equipping of layers or an assembly of a plurality of layers can be performed in each case to form the dual cartridge, so that after the dual cartridge has been separated into two separate analysis devices, a part placed therein in a single step of equipping can be present in each of the analysis devices.

According to a further embodiment, the step of providing and additionally or alternatively, the step of equipping may be performed repeatedly. For example, multiple execution of the steps of providing and equipping may be performed to advantageously form a multi-layered dual cartridge having inlaid parts such as reagent bars or solid reagents. For example, a step of equipping may be followed by a step of arranging as well as a step of providing in order to enclose or provide an enclosure within the dual cartridge for the elements which may have been introduced in the step of equipping into a layer or assembly consisting of a plurality of layers for the manufacture of a dual cartridge.

According to a further embodiment, the method may be performed as a step of attaching a film to the layer and additionally or alternatively to the further layer using a carrier film. For example, a polymer film may be applied to a carrier film, a so-called liner, during manufacture. After the polymer film has been provided with the layer and additionally or alternatively the further layer on the side facing away from the carrier film, the carrier film can be peeled off. In this way, the carrier film can serve in a particularly advantageous manner to ensure that the polymer film can be applied simultaneously to both halves of the dual cartridge on the one hand and, on the other hand, is already present in separated form on the two contiguous halves of the dual cartridge after removal of the carrier film. Advantageously, this means that it is no longer necessary to cut the film when separating the dual cartridge. This is particularly advantageous if the polymer film has elastic properties, which can make it difficult to make a defined separation along a separation line set by means of a perforation.

In addition, a method for manufacturing microfluidic analysis devices from a dual cartridge is presented, wherein the method comprises a step of providing a variant of the previously presented dual cartridge and a step of separating the first analysis device and the second analysis device along the connection point. In the step of separating, the dual cartridge formed from the contiguous analysis devices can be separated in order to obtain two separate analysis devices. The separation can be accomplished by mechanically breaking along predetermined breaking points, for example, or by means of another type of separating method.

Also presented is a method for using an analysis device manufactured according to the method previously presented, wherein the method comprises a step of introducing the analysis device into an analysis unit, a step of processing the analysis device in the analysis unit, and a step of outputting the analysis device from the analysis unit.

This method can be implemented, for example, in software or hardware or in a mixed form of software and hardware, for example in a control unit.

For this purpose, the control unit can comprise at least one computing unit for processing signals or data, at least one memory unit for storing signals or data, at least one interface with a sensor or an actuator for reading in sensor signals from the sensor or for outputting control signals to the actuator, and/or at least one communication interface for reading in or outputting data embedded in a communication protocol. The computing unit can be a signal processor, a microcontroller or the like, for example, wherein the memory unit can be a flash memory, an EEPROM or a magnetic memory unit. The communication interface can be configured to read in or output data wirelessly and/or by wire, wherein a communication interface capable of reading in or outputting data transmitted by wire can read said data, for example electrically or optically, from a corresponding data transmission line or output the data to a corresponding data transmission line.

A control unit can be understood here to be an electrical device that processes sensor signals and outputs control signals and/or data signals as a function thereof. The control unit can have an interface, which can be formed by hardware and/or software. In a hardware design, the interfaces can, for example, be part of a so-called system ASIC, which contains various functions of the control unit. However, it is also possible that the interfaces are separate, integrated circuits or at least partially consist of discrete structural elements. Given a software design, the interfaces can be software modules provided on, e.g., a microcontroller in addition to other software modules.

Embodiment examples of the approach presented here are shown in the drawings and explained in greater detail in the following description. The drawings show:

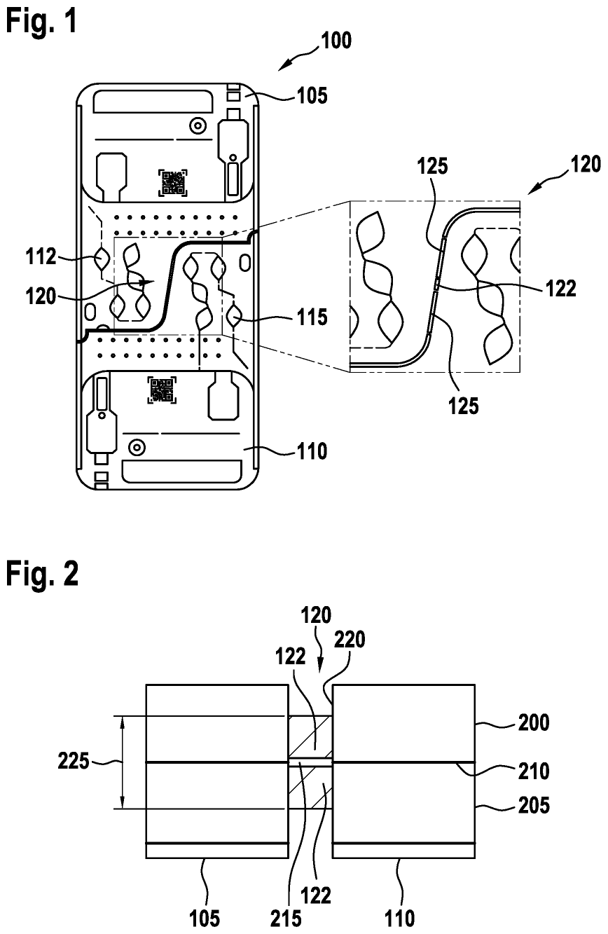

FIG. 1 a schematic top view of a dual cartridge according to an exemplary embodiment;

FIG. 2 a schematic cross-sectional view of the connection point along the first connection element according to an exemplary embodiment;

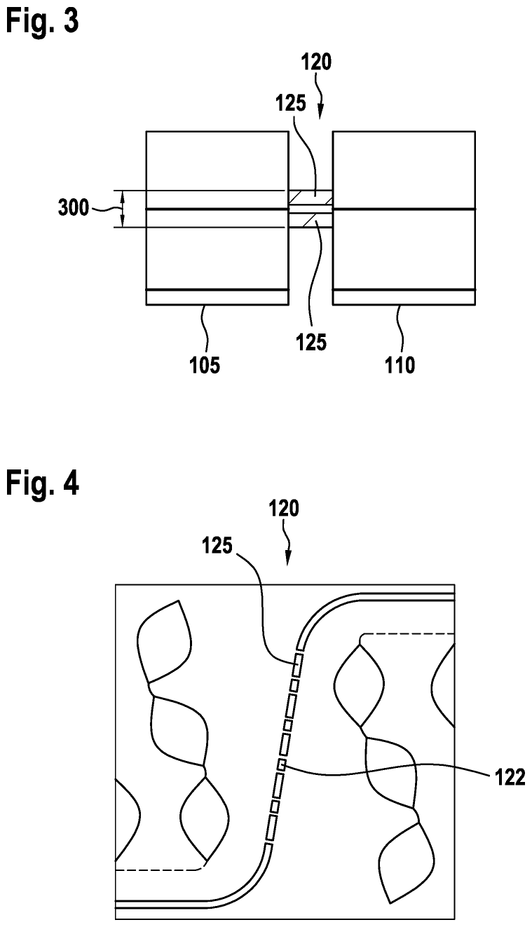

FIG. 3 a schematic cross-sectional view of the connection point along the second connection element according to an exemplary embodiment;

FIG. 4 a schematic top view of a connection point according to an exemplary embodiment;

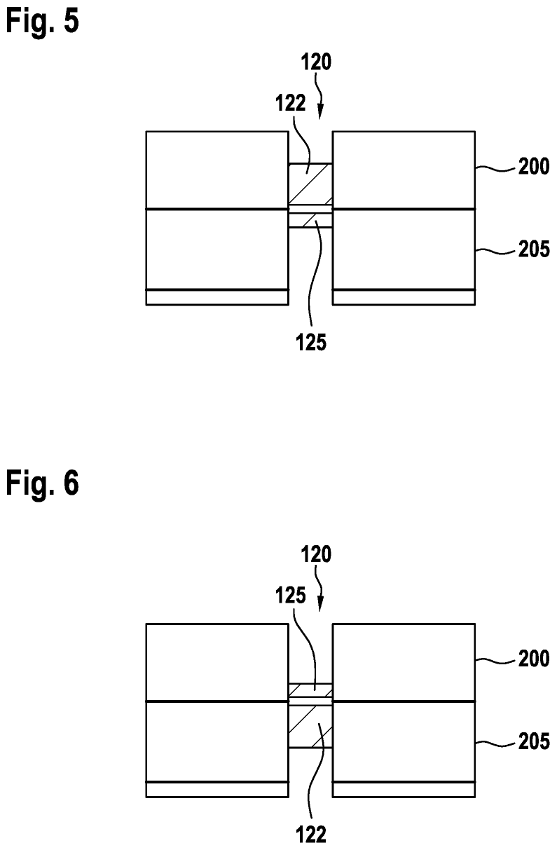

FIG. 5 a schematic cross-sectional view of the connection point according to an exemplary embodiment;

FIG. 6 a schematic cross-sectional view of the connection point according to an exemplary embodiment;

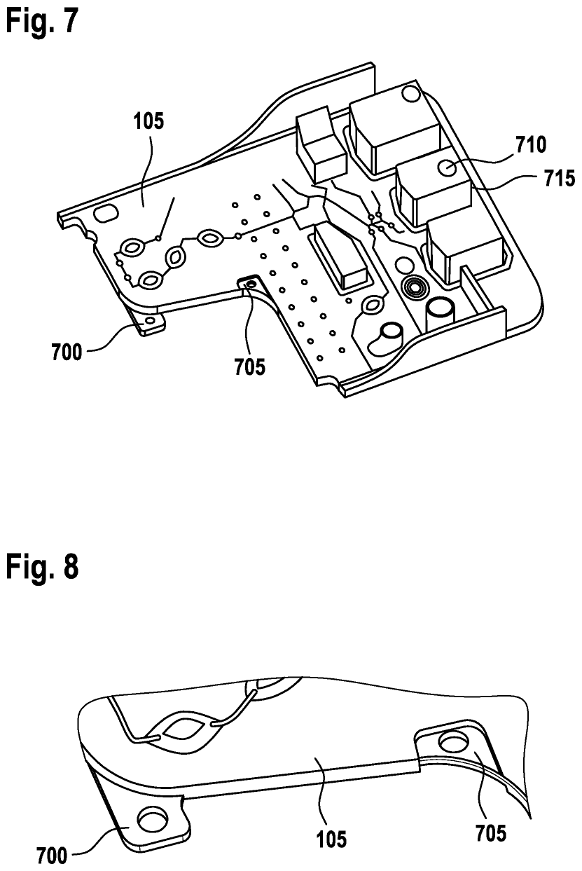

FIG. 7 a top perspective view of a first analysis device according to an exemplary embodiment;

FIG. 8 a top view of a section of a first analysis device according to an exemplary embodiment;

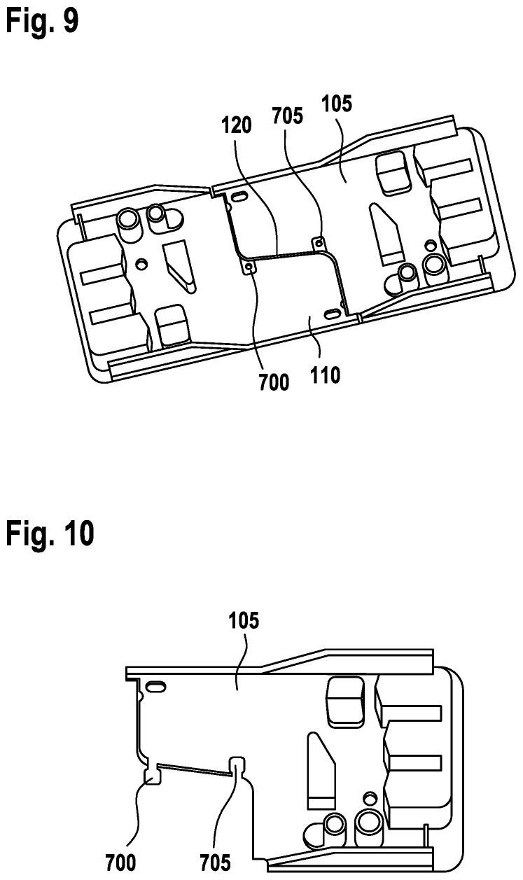

FIG. 9 a schematic top view of an exemplary embodiment of a dual cartridge having a click-press connection;

FIG. 10a top perspective view of a first analysis device according to an exemplary embodiment;

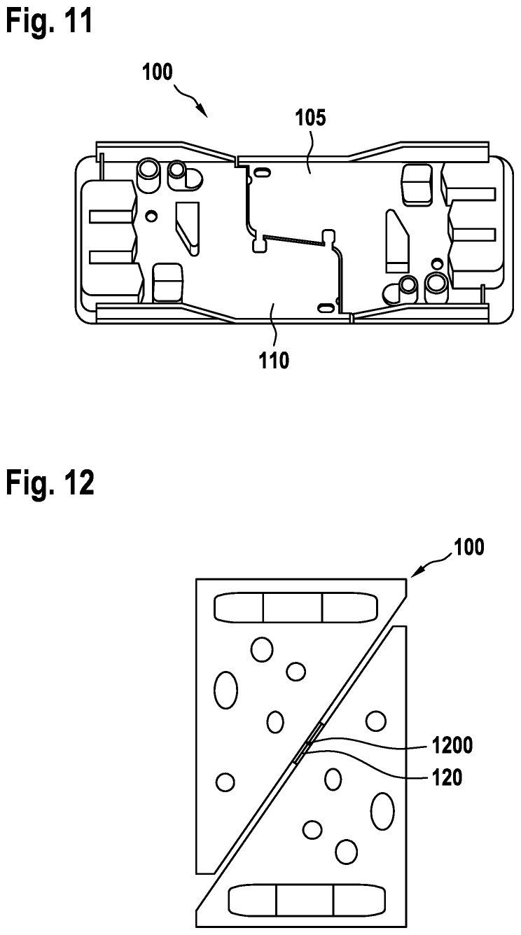

FIG. 11 a schematic top view of an exemplary embodiment of a dual cartridge having a jigsaw-press connection;

FIG. 12 a schematic top view of a dual cartridge according to an exemplary embodiment;

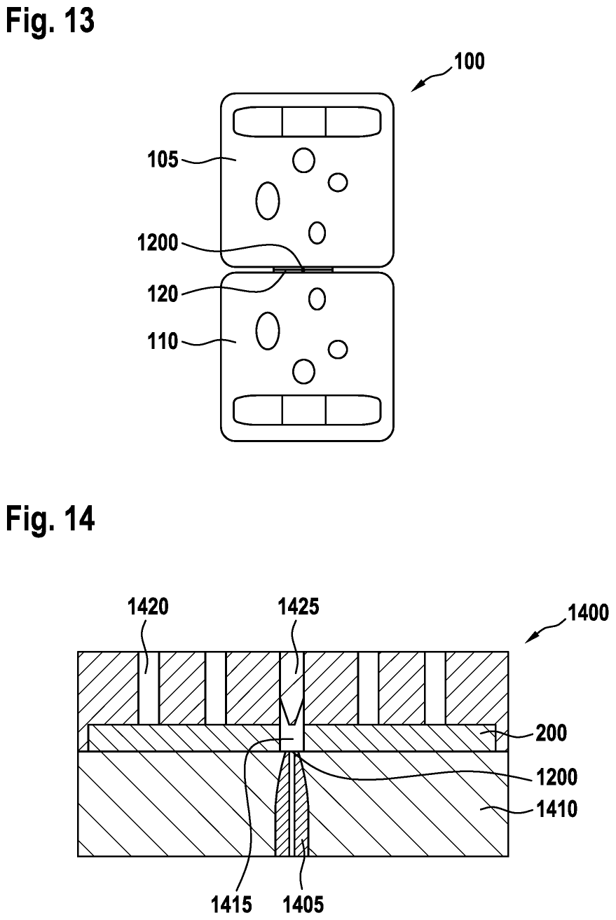

FIG. 13 a schematic top view of a dual cartridge according to an exemplary embodiment;

FIG. 14 a schematic cross-sectional view of an exemplary embodiment of an injection molding tool for injection molding a layer of a dual cartridge;

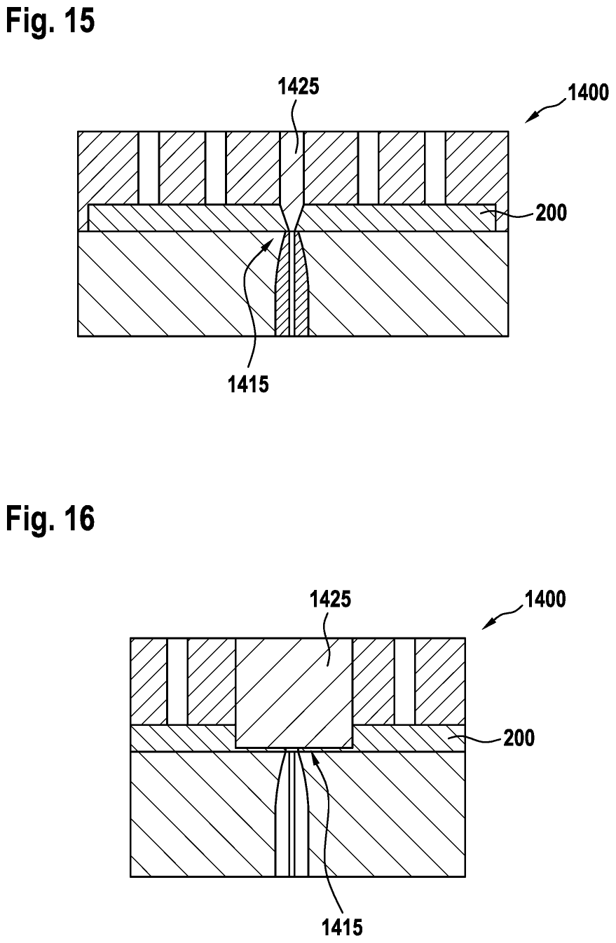

FIG. 15 a schematic cross-sectional view of an exemplary embodiment of an injection molding tool for injection molding a layer of a dual cartridge;

FIG. 16a schematic cross-sectional view of an exemplary embodiment of an injection molding tool for injection molding a layer of a dual cartridge;

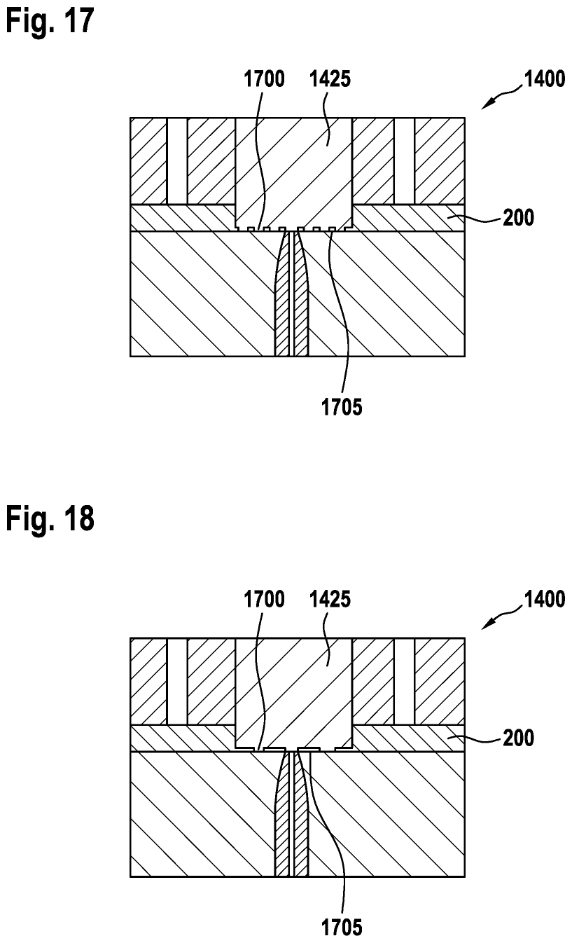

FIG. 17 a schematic cross-sectional view of an exemplary embodiment of an injection molding tool for injection molding a layer of a dual cartridge;

FIG. 18 a schematic cross-sectional view of an exemplary embodiment of an injection molding tool for injection molding a layer of a dual cartridge;

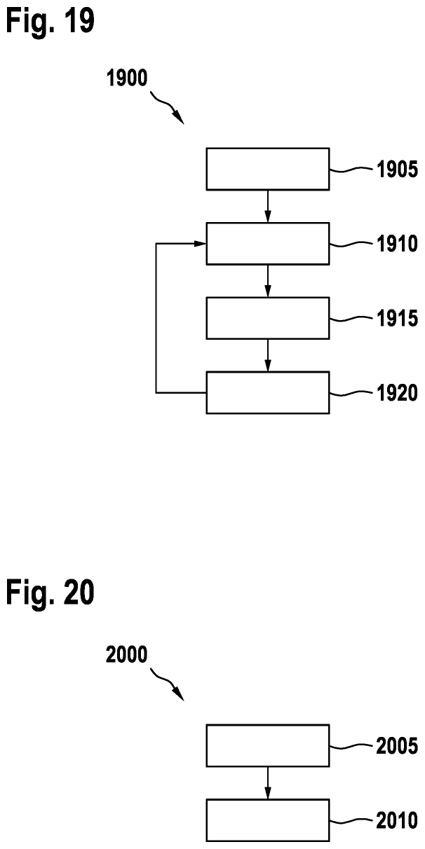

FIG. 19 a flow chart of a method for manufacturing a microfluidic dual cartridge according to one exemplary embodiment;

FIG. 20 a flow chart of a method for manufacturing microfluidic analysis devices from a dual cartridge according to an exemplary embodiment; and

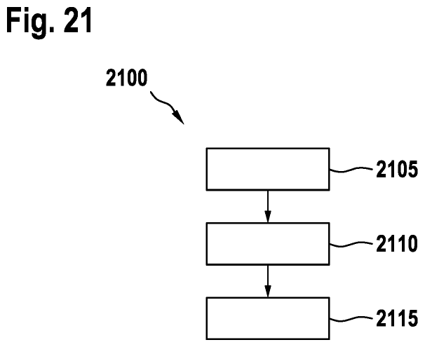

FIG. 21 a flow chart of a method for using an analysis device according to one exemplary embodiment.

In the following description of favorable embodiment examples of the present invention, identical or similar reference numbers are used for the elements shown in the various figures and acting similarly, wherein a repeated description of these elements is dispensed with.

FIG. 1 shows a schematic top view of a dual cartridge 100 according to an exemplary embodiment. The dual cartridge 100 comprises a first microfluidic analysis device 105 for processing sample material and a second microfluidic analysis device 110 for processing sample material. By way of example only, the first analysis device 105 and the second analysis device 110 can be of identical shape and function so that they can be individually used after the separation. By way of example only, the first analysis device 105 comprises a first microfluidic network 112 and the second analysis device 110 comprises a second microfluidic network 115 congruent with the first network 112. In other words, the dual cartridge 100 is composed of two similar, separately usable lab-on-chip cartridges interconnected via a connection point 120. In this case, the connection point 120 between the analysis devices 105, 110 is formed to effect a defined separation of the first analysis device 105 and the second analysis device 110 under the effect of a force. In this exemplary embodiment, the connection point 120 is formed as a predetermined breaking point or predetermined breaking element. In another exemplary embodiment, the connection point may additionally or alternatively have a cut edge. In this embodiment, the dual cartridge is largely manufactured using an amorphous plastic. The brittle material properties of the amorphous plastic used allow for the dual cartridge 100 to be easily mechanically separated by breaking along the connection point 120. In another exemplary embodiment, the separation of the analysis devices can also be performed by cutting along a cut edge, for example with commercially available scissors at a transition with different cross-sections due to shear, bend, or torsion forces. In the illustration shown here, the exact design of the connection point 120 is shown on the right side of the figure as an enlarged view. In this embodiment, the predetermined breaking element is suitably formed to allow, on the one hand, a defined separation of the dual cartridge 100 into two analysis devices 105, 110 and, on the other hand, to establish a mechanical connection between the different analysis devices 105, 110 forming the dual cartridge 100. Thus, the connection point 120 has sufficient stability to allow for safe handling of the analysis devices 105, 110 when manufacturing the dual cartridge 100. To this end, in this embodiment, the connection point 120 is composed of a first connection element 122 and a second connection element 125. Both connection elements 122, 125 serve to stiffen the dual cartridge 100 to provide, by way of example only, sufficient mechanical stability of the analysis devices 105, 110 when manufacturing the dual cartridge 100. While the first connection element 122 ostensibly causes stiffening of the dual cartridge 100 with respect to mechanical forces acting perpendicular to the plane of the dual cartridge 100, the second connection element 125 provides, by way of example only, stiffening within the plane of the dual cartridge 100 to prevent torsion of the analysis devices 105, 110 forming the dual cartridge 100 with respect to each other. In this embodiment, the first connection element 122 also acts as a predetermined breaking point if the mechanical forces acting perpendicular to the plane of maximum spatial expansion of the dual cartridge 100 exceed a critical value, which depends in particular on the material properties as well as the geometric dimensions of the first connection element 122. In this embodiment, the dual cartridge has total lateral dimensions of 187×78 mm², wherein the first analysis device 105 and the second analysis device 110 each have total lateral dimensions of 118×78 mm², by way of example only. In another embodiment, the dual cartridge may have total lateral dimensions of 20×10 mm² to 300×200 mm², preferably 75×25 mm² to 200×100 mm², and the first analysis device 105 and the second analysis device 110 may each have total lateral dimensions of 10×10 mm² to 280×200 mm², preferably 37×25 mm² to 150×100 mm².

FIG. 2 shows a schematic cross-sectional view of the connection point 120 along the first connection element 122 according to an exemplary embodiment. The connection point 120 shown here corresponds to or resembles the connection point described in the preceding figure. In this embodiment, the first analysis device 105 and the second analysis device 110 each comprise a plurality of layers. In other words, the dual cartridge described in the previous FIG. 1 has a five-layer construction, by way of example only. In this embodiment, a layer 200 is configured to guide a microfluidic network and can be equipped with elements such as a reagent bar or reaction bead, by way of example only. In this embodiment, the layer 200 is formed with the first connection element 122 of the connection point 120, as is a further layer 205 of the plurality of layers. An additional layer 210, by way of example only, is arranged between the layer 200 and the further layer 205, which in this exemplary embodiment is configured as a film, wherein the film along the connection point 120 comprises a perforation 215 for defined separation of the first analysis device 105 and the second analysis device 110, by way of example only. In another exemplary embodiment, the film may also have an indentation or the first analysis device may comprise a first film and the second analysis device may comprise a second film having no connection to the first film. In addition to the material properties, the design of the inner edges 220 of the analysis devices as well as the height 225 of the first connection element 122 are in particular decisive for the breaking behavior when the dual cartridge described in the preceding FIG. 1 is separated along the connection point 120. The higher the first connection element 122 and the lower the present fillet at the inner edges 220, the higher the mechanical stress acting on the material at the inner edges 220. If this locally exceeds a material-specific critical value, the material breaks starting from the inner edge 220. In this way, therefore, a defined manual separation of the dual cartridge by moderate application of force by a user can be achieved by suitable selection of material properties and geometric dimensions of the connection point 120. Due to a significant width of the dual cartridge compared to the height 225 of the first connection element 122, i.e., only by way of example many times greater, and the resulting leverage effect on the inner edge 220 of the first connection element 122, the dual cartridge can be reliably separated into the analysis devices with only moderate force when the cartridge is bent by hand. In this embodiment, a layer thickness of the first connection element 122 is 500 μm, by way of example only. In another exemplary embodiment, the layer thickness may be 200 μm to 1200 μm, preferably 400 μm to 1000 μm.

FIG. 3 shows a schematic cross-sectional view of the connection point 120 along the second connection element 125 according to an exemplary embodiment. The connection point 120 shown here corresponds to or resembles the connection point described in the preceding figures. The second connection element 125 is configured in this embodiment to provide stiffening within the plane of the dual cartridge described in the preceding FIG. 1 and to prevent torsion of the analysis devices 105, 110 forming the dual cartridge relative to each other. Accordingly, a height 300 of the second connection element 125 is less than the height of the first connection element described in the preceding FIG. 2. In this exemplary embodiment, a layer thickness of the second connection element 125 is 200 μm, by way of example only. In another exemplary embodiment, the layer thickness may be 100 μm to 600 μm, preferably 100 μm to 400 μm.

FIG. 4 shows a schematic top view of a connection point 120 according to an exemplary embodiment. The connection point shown here corresponds to or resembles the connection point described in the preceding figures, with the difference that the connection point 120 comprises a plurality of first connection elements 122 and second connection elements 125 for stiffening and defining the predetermined breaking connection point, wherein the connection elements 122, 125 are partially arranged above each the other as described in more detail in the following FIGS. 5 and 6.

FIG. 5 shows a schematic cross-sectional view of the connection point 120 according to an exemplary embodiment. The connection point 120 shown here corresponds to or resembles the connection point described in the preceding figures, with the difference that in this embodiment, the layer 200 forms the first connection element 122, while the further layer 205 forms the second connection element 125.

FIG. 6 shows a schematic cross-sectional view of the connection point 120 according to an exemplary embodiment. The connection point 120 shown here corresponds to or resembles the connection point described in the preceding figures, with the difference that in this embodiment, the layer 200 forms the second connection element 125, while the further layer 205 forms the first connection element 122.

FIG. 7 shows a top perspective view of a first analysis device 105 according to an exemplary embodiment. In another exemplary embodiment, this may also be a layer 200 for forming a first analysis device 105, by way of example only. The first analysis device 105 shown herein corresponds to or resembles the first analysis device described in the preceding figures, with the difference that in this embodiment, the connection point 120 of the first analysis cartridge 105 is formed by a first form-fit connection element 700 and a second form-fit connection element 705 for a form-fit connection of the first analysis device 105 to a second analysis device. As an alternative to the material-fit design of the connection point 120 described in the preceding figures, in this exemplary embodiment the connection of the two lab-on-chip cartridges to form a dual cartridge 100 can be achieved by a press connection with a form-fit. In this embodiment, the first form-fit connection element 700 and the second form-fit connection element 705 each form part of a so-called click-press connection consisting of two complementary elements for connection to the second analysis device. The click-press connection is composed of the first positive form-fit connection element 700 and a second positive form-fit connection element 705, by way of example only, which allows a press connection to be established by mechanically engaging with equally formed complementary form-fit connection elements of the second analysis device. In this embodiment, the first form-fit connection element 700 has a tab having a pin, by way of example only, whereas the complementary second form-fit connection element 705 is characterized by a pocket having a bore, by way of example only. The click-press connection can thus be achieved by engaging the tab in the pocket as well as the pin in the bore. In addition, in this exemplary embodiment, the first analysis device 105 is equipped with an additional element 710, by way of example only. The element is a reagent bar which is inserted into a liquid reagent receptacle 715 provided for it, by way of example only.

FIG. 8 shows a top view of a section of a first analysis device 105 according to an exemplary embodiment. The first analysis device 105 shown here corresponds to or resembles the analysis device described in the preceding figures. The section shown here shows the click-press connection described in the preceding FIG. 7 and comprises the first form-fit connection element 700 and the complementary second form-fit connection element 705.

FIG. 9 shows a schematic top view of an exemplary embodiment of a dual cartridge 100 with a click-press connection. The dual cartridge 100 shown here corresponds to or resembles the dual cartridge described in the preceding FIG. 1 with the difference that the dual cartridge 100 in this embodiment has a connection point 120 having a first form-fit connection element 700 and a complementary second form-fit connection element 705. The first analysis device 105 of the dual cartridge 100 and the second analysis device 110 of the dual cartridge 100 are connected to each other with a form-fit by the first form-fit connection element 700 and the second form-fit connection element 705. In another exemplary embodiment, a material-fit connection can also additionally or alternatively be configured.

FIG. 10 shows a top perspective view of a first analysis device 105 according to an exemplary embodiment. The first analysis device 105 shown here corresponds to or resembles the first analysis device described in the preceding figures and, similar to the first analysis device described in the preceding FIGS. 7, 8, and 9, comprises a first form-fit connection element 700 and a second form-fit connection element 705 for a form-fit connection to a second analysis device. In contrast to the click-press connection described in the preceding FIGS. 7, 8, and 9, the first form-fit connection element 700 and the second form-fit connection element 705 are formed as a so-called jigsaw-press connection in this exemplary embodiment. The jigsaw-press connection also consists of two complementary elements which allow for a press connection between two similar analysis devices by mechanically engaging one another. In contrast to the click-press connection, the first form-fit connection element 700 and the second form-fit connection element 705 of the jigsaw-press connection do not have a pin or bore in this embodiment. Instead, the jigsaw-press connection is based on a first form-fit connection element 700 formed as a tab with a protuberance, and a complementary second form-fit connection element 705, which is formed as a pocket with an inversion. By engaging the tab with the protuberance into the pocket with the inversion, a jigsaw-press connection can be established.

FIG. 11 shows a schematic top view of an exemplary embodiment of a dual cartridge 100 with a jigsaw-press connection. The dual cartridge 100 shown here corresponds to or resembles the dual cartridge described in the preceding FIGS. 1 and 9, with the difference that in this embodiment the first analysis device 105 and the second analysis device 110 are connected by a jigsaw-press connection as described in the preceding FIG. 10.

FIG. 12 shows a schematic view of a dual cartridge 100 according to an exemplary embodiment. The dual cartridge 100 shown here corresponds to or resembles the dual cartridge described in the preceding FIGS. 1, 9, and 11. In this embodiment, the connection point 120 is formed by an injection point 1200 of an injection mold. By way of example only, the dual cartridge 100 is manufactured using polycarbonate (PC) in an injection molding process. In another embodiment, the dual cartridge may additionally or alternatively comprise other amorphous plastics, such as polystyrene (PS), styrene-acrylonitrile copolymer (SAN), polypropylene (PP), polyethylene (PE), polymethylpentene (PMP), cycloolefin copolymer (COP, COC), polymethyl methacrylate (PMMA), polydimethyl siloxane (PDMS), or thermoplastic elastomers (TPE) based on polyurethane (TPU) or styrenic block copolymer (TPS) and the dual cartridge may be manufactured by serial manufacturing methods such as injection punching, thermoforming, punching, or laser transmission welding.

FIG. 13 shows a schematic view of a dual cartridge 100 according to an exemplary embodiment. The dual cartridge 100 shown here corresponds to or resembles the dual cartridge described in the preceding FIGS. 1, 9, 11, and 12, wherein the connection point 120 is formed by an injection point 1200 of an injection mold, by way of example only. The amorphous plastic used in injection molding in this embodiment is of a correspondingly brittle nature, and by a hand movement involving bending or torsion forces, the first analysis device 105 and the second analysis device 110 are separable from each other along the connection point 120.

FIG. 14 shows a schematic cross-sectional view of an exemplary embodiment of an injection molding tool 1400 for injection molding a layer 200 of a dual cartridge as described in the preceding FIGS. 1, 9, 11, 12, and 13. In this case, the layer 200, which can also be referred to as a carrier plate, is formed from transparent plastic that is still liquid in the illustration shown here. In this embodiment, an injection point 1200 of a hot runner 1405 is positioned in the nozzle side 1410 of the injection molding tool 1400 exactly between the cavities of the carrier plate at a transition region 1415 that forms the connection point described in the preceding figures after the injection molding process has been completed. For this purpose, in this exemplary embodiment, a punch 1425 directly opposite in the ejector side 1420 of the injection molding tool 1400 can be advanced and formed with a sharp punching edge to notch the transition region 1415.

FIG. 15 shows a schematic cross-sectional view of an exemplary embodiment of an injection molding tool 1400 for injection molding a layer 200 of a dual cartridge as described in the preceding FIGS. 1, 9, 11, 12, and 13. The injection molding tool 1400 corresponds to or resembles the injection molding tool described in the preceding FIG. 14. In the illustration shown here, the punch 1425 is lowered and the transition region 1415 is indented. By way of example only, the remaining thin transition region 1415 still has a thickness of between 100 μm and 400 μm.

FIG. 16 shows a schematic cross-sectional view of an exemplary embodiment of an injection molding tool 1400 for injection molding a layer 200 of a dual cartridge as described in the preceding FIGS. 1, 9, 11, 12, and 13. The injection molding tool 1400 corresponds to or resembles the injection molding tool described in the preceding FIGS. 14 and 15, with the difference that the punch 1425 is flattened.

FIG. 17 and FIG. 18 show a schematic cross-sectional view of an exemplary embodiment of an injection molding tool 1400 for injection molding a layer 200 of a dual cartridge as described in the preceding FIGS. 1, 9, 11, 12 and 13. The injection molding tool 1400 corresponds to or resembles the injection molding tool described in the preceding FIGS. 14, 15, and 16 with the difference that the punch 1425 is formed with elevations 1700 to form a plurality of small connection points 1705 in the layer 200. By way of example only, the connection points in the exemplary embodiments shown have a square shape and the connection points have a width of 200 μm and a thickness of 100 μm. In another exemplary embodiment, the connection points may be rectangular or semi-circular and have a width of between 200 μm to 3000 μm and a thickness of between 100 μm to 500 μm.

FIG. 19 shows a flow chart of a method 1900 for manufacturing a microfluidic dual cartridge according to an exemplary embodiment. The method 1900 comprises a step 1905 of providing a layer for the dual cartridge, wherein the layer comprises a first portion for forming a part of the first analysis device and a second portion for shaping a part of the second analysis device, and the connection point for connecting the two portions. The first portion and the second portion may also be referred to as a semi-finished product. By way of example only, in this embodiment, the layer to be provided is a transparent carrier plate. In this embodiment, an injection molding machine with an ejector embossing function as well as a handling system and a multi-cavity injection mold with a hot runner are required to implement the step 1905 of providing. The injection point of the hot runner is positioned, by way of example only, in the nozzle side of the injection mold exactly between the cavities of the carrier plates at a transition region. In this embodiment, immediately after injection of the transparent plastic melt, a punch with a sharp cutting edge directly opposite in the ejector side is advanced over the entire plate thickness via the ejector stamping function of the injection molding machine and produces a notched thin transition cross-section. In another exemplary embodiment, a plurality of small connection points may additionally or alternatively be indented over a width of between 10 mm and 40 mm at an additionally compressed edge region between the carrier plates. In this case, the remaining thin transition cross-section has a thickness of between 100 μm and 400 μm, by way of example only. However, the transition is still stable enough to allow the plates to be removed from the injection mold and fed to the assembly line after a certain cooling time in conjunction with the handling system. Since, for example, during the assembly of two smaller cartridges on the tool carrier of a large cartridge, only perpendicular forces act on the carrier plates, the transition region remains mechanically stable here as well. In this exemplary embodiment, step 1905 also comprises arranging the layer on a tool carrier. In this case, the produced semi-finished products are planar, at least in partial areas, by way of example only, or have identical or at least similar lateral dimensions. By way of example only, the tool carrier has alignment pins which engage in alignment holes in the semi-finished products in order to achieve a defined positioning of the semi-finished products on the tool carrier as well as a defined relative positioning of the at least two semi-finished products with respect to each other. The latter serves in this embodiment to prepare a subsequent step 1910 of providing. In the step 1910 of providing, the layer is provided with a further layer to produce the dual cartridge. Providing this exemplary embodiment is carried out with a series production technology of laser transmission welding. In this case, the layer and the further layer are pressed onto each other, for example, to achieve consistently good thermal conduction between the layers during the welding process. By way of example only, the step 1910 of providing in this exemplary embodiment is followed by an additional step 1915 of attaching a film to the layer and to the further layer using a carrier film. By way of example only, the film is a polymer film applied to a carrier film, a so-called liner, during production. After the polymer film has been provided with a further polymer part on the side facing away from the carrier film, the carrier film is peeled off. In this way, the film is applied simultaneously, on the one hand, to the first portion and the second portion of the layer by means of the carrier film and, on the other hand, is already present in separated form on the two contiguous portions of the layer after the carrier film has been removed. In this embodiment, the method 1900 also comprises a step 1920 of equipping the layer with at least one microfluidic element. The element, which may also be referred to as a further part, is a reagent bar which is inserted into a liquid reagent receptacle provided for it, by way of example only. In another embodiment, for example, the microfluidic element may be a reaction bead, i.e., a freeze-dried or lyophilized solid reagent, which may be introduced, for example, into a recess provided for this purpose in a semi-finished product or an assembly of a plurality of semi-finished products to form the dual cartridge. Equipping with additional parts may be carried out, for example, by inlaying, inserting, or attaching and/or snapping. Additionally or alternatively, the layer and, additionally or alternatively, the further layer may be equipped with, for example, an array carrier element, such as a hybridization array or a microcavity array, which may be inserted into the dual cartridge to perform detection reactions. For example, the array carrier element may be glued into the semi-finished product or assembly from a plurality of semi-finished products to form the dual cartridge. In this exemplary embodiment, the first portion and the second portion of the layer are each double equipped to form the dual cartridge, such that upon separating the dual cartridge into two separate lab-on-chip cartridges, each of the lab-on-chip cartridges has a part introduced therein in a step of equipping. In addition, in this exemplary embodiment, step 1910 of providing and step 1920 of equipping are performed repeatedly. By way of example only, the arrangement of the layer on the tool carrier is performed repeatedly. By way of example only, multiple versions of arranging, providing, and equipping are performed to form a multi-layered dual cartridge having inlaid portions such as reagent bars and solid reagents. In another exemplary embodiment, a step of equipping may be followed by a step of arranging and a step of providing to enclose or provide an enclosure within the dual cartridge for the parts which were introduced in the step of equipping in a semi-finished product or an assembly consisting of a plurality of semi-finished products to manufacture a dual cartridge.

FIG. 20 shows a flow chart of a method 2000 for manufacturing microfluidic analysis devices from a dual cartridge according to an exemplary embodiment. The method 2000 comprises a step 2005 of providing a dual cartridge according to a variant of the method described in the preceding FIG. 19 for manufacturing a dual cartridge. In addition, the method 2000 comprises a step 2010 of separating the first analysis device and the second analysis device along the connection point. In the step of separating 2010, the dual cartridge formed from the contiguous portions or semi-finished products is separated to obtain two separate analysis devices. In this exemplary embodiment, the separating is carried out by mechanically breaking along predetermined breaking points. In another exemplary embodiment, the separating may be performed by a different type of separation method. In an exemplary embodiment, the step of separating may be followed by an additional step of packaging the separated analysis devices. For example, packaging can be carried out in an airtight sealed aluminum film (pouch), which can contain a dry bag to enable long-term stable packaging and storage of the dual cartridge or the analysis devices. If the dual cartridge is separated by the user, a resealable sleeve can in particular be used as the packaging. If necessary, a moisture indication may be incorporated into the analysis device and the analysis device may be checked during repeated unpacking. In further embodiments of the method 2000 for manufacturing an analysis device, individual steps can be omitted or repeated or can be interchanged with other steps in the sequence. For example, the step 2010 of separating may be omitted, wherein the separation of the dual cartridge is first performed by a user.

FIG. 21 shows a flow chart of a method 2100 for using an analysis device according to an exemplary embodiment, wherein the analysis device was manufactured with a variant of the method for manufacturing an analysis device described in the preceding FIG. 20. The method 2100 comprises a step 2105 of inserting the analysis device into an analysis device. In the step 2105 of inserting, the analysis device is inserted into an analysis unit. There follows a step 2110 of processing the analysis device in the analysis unit, wherein the analysis device is processed in the analysis unit to process a sample therein, by way of example only. In addition, the method 2100 comprises a step 2115 of outputting the analysis device into an analysis unit. In this case, the analysis unit is output from the analysis device and, optionally, an additional analysis result is output.

1. A microfluidic dual cartridge, comprising:
a first microfluidic analysis device configured to process sample material; and
a second microfluidic analysis device configured to process sample material,
wherein the first and the second microfluidic analysis devices are interconnected at a connection point, and
wherein the connection point is configured to bring about a defined separation of the first microfluidic analysis device and the second microfluidic analysis device under the effect of a force.

2. The microfluidic dual cartridge according to claim 1, wherein:
the first microfluidic analysis device and the second microfluidic analysis device are configured to be of identical shape; and/or
the first microfluidic analysis device and the second microfluidic analysis device are configured for individual use after the separation.

3. The microfluidic dual cartridge according to claim 1, wherein the connection point is at least partially formed as a material-fit predetermined breaking point and/or cut edge.

4. The microfluidic dual cartridge according to claim 1, wherein the connection point is formed by an injection point in an injection molding process.

5. The microfluidic dual cartridge according to claim 1, wherein the connection point is at least partially formed by complementary form-fit connection elements for form-fit connection of the first microfluidic analysis device to the second microfluidic analysis device.

6. The microfluidic dual cartridge according to claim 1, further comprising:
a plurality of layers,
wherein at least one layer of the plurality of layers comprises a microfluidic network, and
wherein (i) the at least one layer or another layer of the plurality of layers is formed with the connection point, and/or (ii) the at least one layer and/or the further layer are equipped with at least one microfluidic element.

7. The microfluidic dual cartridge according to claim 6, wherein:
an additional layer of the plurality of layers comprises a film, and
the film comprises an indentation and/or a perforation for defined separation of the first microfluidic analysis device and the second microfluidic analysis device at the connection point.

8. The microfluidic dual cartridge according to claim 1, wherein one of the first microfluidic analysis device and the second microfluidic analysis device comprises at least one portion of the connection point.

9. A method for manufacturing a microfluidic dual cartridge comprising:
providing a layer for the microfluidic dual cartridge, the layer comprises (i) a first portion for forming a part of a first microfluidic analysis device of the microfluidic dual cartridge, (ii) a second portion for forming a part of a second microfluidic analysis device, and (iii) a connection point connecting the first portion and the second portion; and
providing the layer with a further layer to produce the microfluidic dual cartridge,
wherein the first microfluidic analysis device is configured to process sample material,
wherein the second microfluidic analysis device configured to process sample material,
wherein the first and the second microfluidic analysis devices are interconnected at the connection point, and
wherein the connection point is configured to bring about a defined separation of the first microfluidic analysis device and the second microfluidic analysis device under the effect of a force.

10. The method according to claim 9, further comprising:
indenting the connection point to form a predetermined breaking point and/or an interface for separating the first and the second microfluidic analysis devices.

11. The method according to claim 9, further comprising:
equipping the layer and/or the further layer with at least one element.

12. The method according to claim 11, further comprising:
repeating the providing the further layer and/or the equipping.

13. The method according to claim 9, further comprising:
attaching a film to the layer and/or to the further layer using a carrier film.

14. The method according to claim 9, further comprising:
separating the first microfluidic analysis device and the second microfluidic analysis device along the connection point.

15. The method according to claim 14, further comprising:
inserting the first and the second microfluidic analysis devices into an analysis unit;
processing the inserted first and second microfluidic analysis devices in the analysis unit; and
outputting the processed first and second microfluidic analysis devices from the analysis unit.
